(19) United States
(12) Patent Application Publication
(10) Pub. No.: US 2026/0043944 A1
(43) Pub. Date: Feb. 12, 2026

(54) OPTICAL FILM, DISPLAY DEVICE, AND ULTRAVIOLET ABSORBING LAYER FORMING COMPOSITION

(71) Applicant: TOPPAN HOLDINGS INC., Tokyo (JP)

(72) Inventors: Kai FUTAMATA, Tokyo (JP); Yoshiko ISHIMARU, Tokyo (JP)

(73) Assignee: TOPPAN HOLDINGS INC., Tokyo (JP)

(21) Appl. No.: 19/364,912

(22) Filed: Oct. 21, 2025

Related U.S. Application Data
(63) Continuation of application No. PCT/JP2024/015736, filed on Apr. 22, 2024.

(30) Foreign Application Priority Data
Apr. 24, 2023 (JP) 2023-070822

(51) Int. Cl. G02B 1/111; G02B 1/04; G02B 5/22

(52) U.S. Cl. CPC G02B 1/111; G02B 1/04; G02B 5/223

(57) ABSTRACT

An optical film includes a hard coat layer, an ultraviolet absorbing layer located on a first surface of the hard coat layer, and a transparent substrate located on a second surface of the hard coat layer. The ultraviolet absorbing layer contains an actinic radiation curable resin and an ultraviolet absorber. The actinic radiation curable resin contains a copolymer of the structural unit represented by a predetermined chemical formula and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit. The optical film 1 has 90% or higher ultraviolet shielding efficiency as measured in accordance with JIS L 1925 and has H or higher pencil hardness at a 500 g load on the surface on the first surface.

### CROSS-REFERENCE TO RELATED PATENT APPLICATIONS

The present application is a Bypass Continuation of International Patent Application No. PCT/JP2024/015736, filed Apr. 22, 2024, which claims priority to and the benefit of Japanese Patent Application No. 2023-070822 filed on Apr. 24, 2023. The contents of these applications are hereby incorporated by reference herein in their entireties.

### TECHNICAL FIELD

The present invention relates to an optical film. The invention also relates to a display device including the optical film and an ultraviolet absorbing layer forming composition associated with the optical film.

### BACKGROUND

Hard coat films are widely used to protect, for example, the screens of displays, touch panels, mobile phones, and other devices.

Mobile products such as mobile phones and smartphones are often used outdoors. Such hard coat films for outdoor use need to have excellent lightfastness, which prevents yellowing and separation between the hard coat layer and the substrate film even after prolonged UV exposure.

To impart weather resistance, Patent Literature 1 proposes adding an ultraviolet absorber or a photostabilizer to the hard coat layer.

Patent Literature 2 proposes a technique for preventing photodegradation of a colored layer as well as a substrate by using a primer layer with a hard coat layer containing an ultraviolet absorber.
[Citation List] [Patent Literature] [PTL 1] JP H09-157315A [PTL 2] WO 2019/065833

### SUMMARY OF THE INVENTION

### Technical Problem

It is well known that a photocurable layer containing an ultraviolet absorber (ultraviolet absorbing layer) does not have good adhesion to the resin layer in contact with it. This is believed to be because a photocurable layer containing an ultraviolet absorber needs a higher exposure dose and more initiator to increase its hardness, and the resultant volume shrinkage and stress, which are greater than usual, reduce the adhesion.

To address this issue, measures have been taken, such as modifying the formulation of the lower layer serving as a base for application of the ultraviolet absorbing layer to adjust surface conditions and flexibility, treating the surface of the lower layer, and applying a primer layer to the lower layer and curing the primer layer with the ultraviolet absorbing layer. However, such measures may not improve the adhesion depending on the type of the ultraviolet absorbing layer or the lower layer, and there is a growing demand for an ultraviolet absorbing layer having good adhesion also from the perspective of reducing the number of process steps.

In view of the above circumstances, an object of the present invention is to provide an optical film including an ultraviolet absorbing layer exhibiting high adhesion.

Another object of the present invention is to provide an ultraviolet absorbing layer forming composition that can form an ultraviolet absorbing layer exhibiting high adhesion.

### Solution to Problem

[1] An optical film according to a first aspect of the present invention includes a first functional layer, an ultraviolet absorbing layer located on a first surface of the first functional layer, and a transparent substrate located on a second surface of the first functional layer.

The ultraviolet absorbing layer contains an actinic radiation curable resin and an ultraviolet absorber.

The actinic radiation curable resin contains a copolymer of the structural unit represented by formula (i) and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit.

This optical film has 90% or higher ultraviolet shielding efficiency as measured in accordance with JIS L 1925 and has H or higher pencil hardness at a 500 g load on the surface on the first surface.

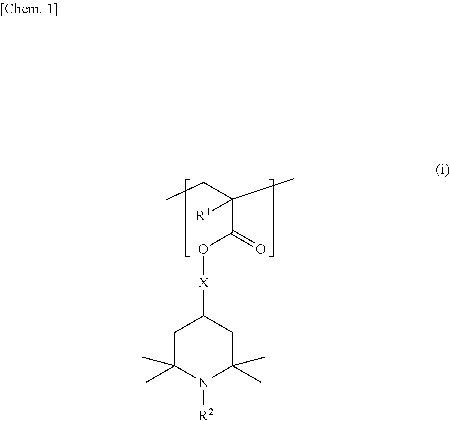

In formula (i), R¹ represents a hydrogen atom, a halogen atom, a carboxyl group, a sulfo group, a cyano group, a hydroxyl group, an alkyl group having ten or fewer carbon atoms, an alkoxycarbonyl group having ten or fewer carbon atoms, an alkylsulfonylaminocarbonyl group having ten or fewer carbon atoms, an arylsulfonylaminocarbonyl group, an alkylsulfonyl group, an arylsulfonyl group, an acylaminosulfonyl group having ten or fewer carbon atoms, an alkoxy group having ten or fewer carbon atoms, an alkylthio group having ten or fewer carbon atoms, an aryloxy group having ten or fewer carbon atoms, a nitro group, an alkoxycarbonyloxy group, an aryloxycarbonyloxy group, an acyloxy group having ten or fewer carbon atoms, an acyl group having ten or fewer carbon atoms, a carbamoyl group, a sulfamoyl group, an aryl group having ten or fewer carbon atoms, a substituted amino group, a substituted ureide group, a substituted phosphono group, or a heterocyclic group; R² represents a hydrogen atom or an alkyl group having 30 or fewer carbon atoms; and X represents a single bond, an ester group, an aliphatic alkyl chain having 30 or fewer carbon atoms, an aromatic chain, a polyethylene glycol chain, or a linking group formed of a combination of them, each of which can contain a spirodioxane ring.
[2] The optical film according to [1], in which the ultraviolet absorbing layer has at least one of an antistatic function, an anti-staining function, and an antiglare function.
[3] The optical film according to [1] or [2], further including a second functional layer located over the first surface of the first functional layer and having a different function than the first functional layer.
[4] The optical film according to [3], in which the second functional layer has at least one of an antireflection function and an antiglare function.
[5] The optical film according to [3], in which the second functional layer is an antistatic layer or an anti-staining layer.
[6] The optical film according to [3], in which the second functional layer is an oxygen barrier layer having an oxygen transmission rate of 10 cm³/(m²·day·atm) or less.
[7] The optical film according to any one of [1] to [6], in which
the first functional layer contains at least one of a first colorant, a second colorant, and a third colorant,
the first colorant has a maximum absorption wavelength ranging from 470 to 530 nm with a half width of an absorption spectrum thereof of 15 to 45 nm,
the second colorant has a maximum absorption wavelength ranging from 560 to 620 nm with a half width of an absorption spectrum thereof of 15 to 55 nm, and
the third colorant has a minimum transmittance at a wavelength ranging from 650 to 780 nm within a wavelength range of 380 to 780 nm.
[8] The optical film according to [7], in which the first functional layer contains a copolymer of the structural unit represented by formula (i) and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit.
[9] The optical film according to [7] or [8], in which the first functional layer contains at least one of a radical scavenger, a peroxide decomposer, and a singlet oxygen quencher.
[10] The optical film according to [9], in which the singlet oxygen quencher contains any one of dialkylphosphate, dialkyldithiocarbonate, benzenedithiol, and a transition metal complex thereof.
[11] The optical film according to any one of [7] to [10], in which at least one of the first colorant, the second colorant, and the third colorant contained in the first functional layer contains at least one compound selected from the group consisting of compounds having any one of a porphyrin structure, a merocyanine structure, a phthalocyanine structure, an azo structure, a cyanine structure, a squarylium structure, a coumarin structure, a polyene structure, a quinone structure, a tetradiporphyrin structure, a pyrromethene structure, and an indigo structure and metal complexes thereof.
[12] A display device according to a second aspect of the present invention includes the optical film according to any one of [1] to [11].
[13] An ultraviolet absorbing layer forming composition according to a third aspect of the present invention includes an ultraviolet absorber, an actinic radiation curable resin, a photoinitiator, and a solvent.

The actinic radiation curable resin contains a copolymer of the structural unit represented by formula (i) and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit.

When a film is formed with a thickness of 5 μm, the film has 90% or higher ultraviolet shielding efficiency as measured in accordance with JIS L 1925.

### Advantageous Effects of the Invention

According to the present invention, an optical film including an ultraviolet absorbing layer exhibiting high adhesion can be provided.

### BRIEF DESCRIPTION OF THE DRAWINGS

FIG. 1 is a schematic cross-sectional view of an optical film according to a first embodiment of the present invention.

FIG. 2 is a schematic cross-sectional view of an optical film according to a second embodiment of the present invention.

FIG. 3 is a schematic cross-sectional view of an optical film according to a third embodiment of the present invention.

FIG. 4 is a schematic cross-sectional view of an optical film according to a fourth embodiment of the present invention.

FIG. 5 is a graph showing the spectrum of white display output through an organic EL light source and a color filter in examples.

FIG. 6 is a graph showing the red display, green display, and blue display spectra output through an organic EL light source and a color filter in examples.

### DETAILED DESCRIPTION

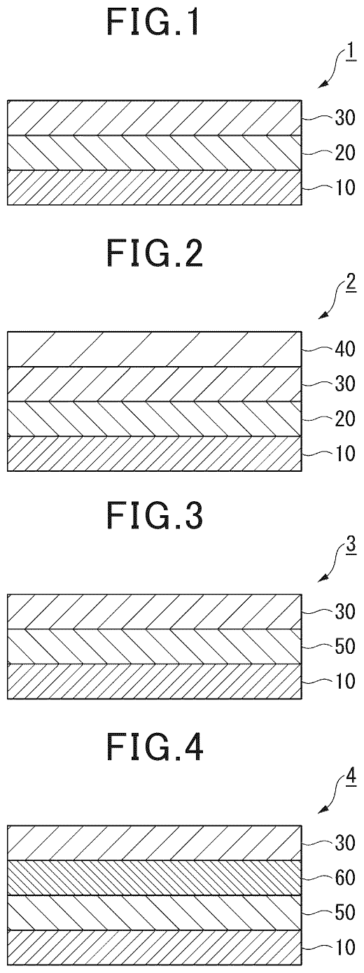

A first embodiment of the present invention is described with reference to FIG. 1.

### [Optical Film]

FIG. 1 is a schematic cross-sectional view of an optical film 1 according to a first embodiment of the present invention.

As illustrated in FIG. 1, the optical film 1 is a laminate including a transparent substrate 10, a hard coat layer (first functional layer) 20, and an ultraviolet absorbing layer 30, with the hard coat layer 20 and the ultraviolet absorbing layer 30 stacked in this order on the transparent substrate 10. That is, the ultraviolet absorbing layer 30 is located on one surface (first surface) of the hard coat layer 20, and the transparent substrate 10 is located on the other surface (second surface).

The thickness of the optical film 1 is, for example, preferably 10 to 140 μm, more preferably 15 to 120 μm, and still more preferably 20 to 100 μm. The thickness of the optical film 1 greater than or equal to the lower limit enables the strength of the optical film 1 to be higher. The thickness of the optical film 1 smaller than or equal to the upper limit enables the optical film 1 to be lighter, as well as such a thickness is advantageous for thinning the display device.

Each layer included in the optical film 1 will now be described.

### Transparent Substrate

The transparent substrate 10 is a sheet-like member.

The transparent substrate 10 can be made of a light-transmissive resin film. The material for forming the transparent substrate 10 may be a transparent resin or inorganic glass. Examples of the transparent resin include polyolefin, polyester, polyacrylate, polyamide, polyimide, polyarylate, polycarbonate, triacetyl cellulose, polyvinyl alcohol, polyvinyl chloride, cycloolefin copolymer, norbornene-containing resin, polyethersulfone, and polysulfone. Examples of the polyolefin include polyethylene and polypropylene. Examples of the polyester include polyethylene terephthalate, polybutylene terephthalate, and polyethylene naphthalate. Examples of the polyacrylate include polymethyl methacrylate. Examples of the polyamide include nylon 6 and nylon 66. Among them, a film made of polyethylene terephthalate (PET), a film made of triacetyl cellulose (TAC), a film made of polymethyl methacrylate (PMMA), or a film made of a polyester except for PET can be preferably used.

The thickness of the transparent substrate 10 may be, but is not limited to, for example, 10 to 100 μm.

The transmittance of the transparent substrate 10 is, for example, preferably 90% or higher.

The transparent substrate 10 may be provided with ultraviolet absorbing ability. The transparent substrate 10 can be provided with ultraviolet absorbing ability by adding an ultraviolet absorber to the resin used as the raw material for the transparent substrate 10.

Examples of the ultraviolet absorber include a salicylate ester-based ultraviolet absorber, a benzophenone-based ultraviolet absorber, a benzotriazole-based ultraviolet absorber, a benzotriazine-based ultraviolet absorber, and a cyanoacrylate-based ultraviolet absorber.

These ultraviolet absorbers may be used singly or in any combination of two or more.

When the transparent substrate 10 is provided with ultraviolet absorbing ability, the ultraviolet shielding efficiency is preferably 85% or higher. The ultraviolet shielding efficiency here is a value measured in accordance with JIS L 1925 and calculated from the following equation:

$$Ultraviolet shielding efficiency ( \% ) = 100 - average transmittance ( \% ) of ultraviolet light from 290 to 400 nm in wavelength$$

### Hard Coat Layer

The hard coat layer 20 is formed on the transparent substrate 10 and in contact with the transparent substrate 10. The hard coat layer 20 serves in the optical film 1 as a reinforcing layer for protecting against damage. Examples of the hard coat layer 20 include a layer formed with a hard coating agent containing monofunctional, bifunctional, or trifunctional or higher functional (meth)acrylate or urethane (meth)acrylate.

As used herein, the term “(meth)acrylate” refers to either acrylate, methacrylate, or both.

### Ultraviolet Absorbing Layer

The ultraviolet absorbing layer 30 is formed on the hard coat layer 20 and in contact with the hard coat layer 20.

The ultraviolet absorbing layer 30 contains an actinic radiation curable resin and an ultraviolet absorber.

The actinic radiation curable resin is a resin that polymerizes and cures upon exposure to actinic radiation such as ultraviolet radiation or an electron beam.

The actinic radiation curable resin according to the present embodiment contains a copolymer of a radical scavenger and a structural unit having any one of (meth)acrylate-based repeating units, olefinic repeating units, halogen-containing repeating units, styrenic repeating units, vinyl acetate-based repeating units, and vinyl alcohol-based repeating units.

The radical scavenger according to the present embodiment is an amine-containing polymer having radical scavenging ability and includes a structural unit represented by formula (i):

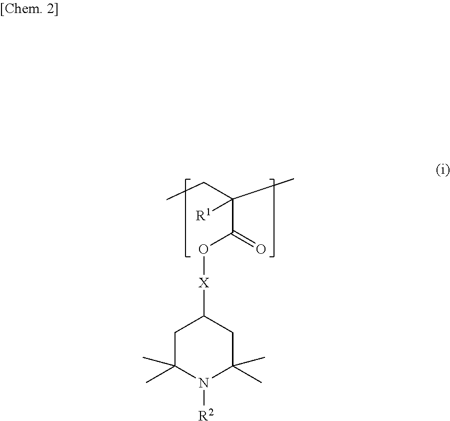

In formula (i), R¹ represents a hydrogen atom, a halogen atom, a carboxyl group, a sulfo group, a cyano group, a hydroxyl group, an alkyl group having ten or fewer carbon atoms, an alkoxycarbonyl group having ten or fewer carbon atoms, an alkylsulfonylaminocarbonyl group having ten or fewer carbon atoms, an arylsulfonylaminocarbonyl group, an alkylsulfonyl group, an arylsulfonyl group, an acylaminosulfonyl group having ten or fewer carbon atoms, an alkoxy group having ten or fewer carbon atoms, an alkylthio group having ten or fewer carbon atoms, an aryloxy group having ten or fewer carbon atoms, a nitro group, an alkoxycarbonyloxy group, an aryloxycarbonyloxy group, an acyloxy group having ten or fewer carbon atoms, an acyl group having ten or fewer carbon atoms, a carbamoyl group, a sulfamoyl group, an aryl group having ten or fewer carbon atoms, a substituted amino group, a substituted ureide group, a substituted phosphono group, or a heterocyclic group; R² represents a hydrogen atom or an alkyl group having 30 or fewer carbon atoms; and X represents a single bond, an ester group, an aliphatic alkyl chain having 30 or fewer carbon atoms, an aromatic chain, a polyethylene glycol chain, or a linking group formed of a combination of them, each of which can contain a spirodioxane ring.

R¹ is preferably a hydrogen atom, a hydroxyl group, or an alkyl group having ten or fewer carbon atoms. The number of carbon atoms in the alkyl group is preferably 1 to 6, and more preferably 1 to 3.

R² is preferably a hydrogen atom or an alkyl group having ten or fewer carbon atoms. The number of carbon atoms in the alkyl group is preferably 1 to 6, and more preferably 1 to 3.

X is preferably a single bond or an aliphatic alkyl chain having 30 or fewer carbon atoms. The number of carbon atoms in the aliphatic alkyl chain is preferably 10 or fewer, more preferably 1 to 6, and still more preferably 2 to 4.

The molecular weight of the structural unit represented by formula (i) is preferably 2000 or greater. The molecular weight greater than or equal to 2000 improves degradation-inhibiting effect on the ultraviolet absorber. This is believed to be because more molecules remain in the ultraviolet absorbing layer 30, providing sufficient degradation-inhibiting effect.

The upper limit of the molecular weight of the structural unit represented by formula (i) can be, but is not limited to, for example, about 100,000 or more.

As used herein, the term “molecular weight” refers to a weight-average molecular weight determined by gel permeation chromatography (GPC) using polystyrene standards.

Examples of repeating units for the copolymer include (meth)acrylate-based repeating units, olefinic repeating units, halogen-containing repeating units, styrenic repeating units, vinyl acetate-based repeating units, and vinyl alcohol-based repeating units.

Examples of the (meth)acrylate-based repeating units include repeating units derived from (meth)acrylate-based monomers with a linear or branched alkyl group in the side chain or repeating units derived from (meth)acrylate-based monomers with a hydroxyl group in the side chain.

Examples of the repeating units derived from (meth)acrylate-based monomers with a linear or branched alkyl group in the side chain include components derived from monomers such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, myristyl (meth)acrylate, pentadecyl (meth)acrylate, hexadecy (meth)acrylate, heptadecyl (meth)acrylate, and octadecyl (meth)acrylate. These may be used singly or in any combination of two or more. Among them, (meth)acrylate-based repeating units with a linear or branched alkyl group having one or more and four or fewer carbon atoms in the side chain can be preferably used.

Examples of the repeating units derived from (meth)acrylic monomers with a hydroxyl group in the side chain include components derived from monomers such as 2-hydroxyethyl (meth)acrylate, 2-hydroxypropyl (meth)acrylate, 4-hydroxybutyl (meth)acrylate, 6-hydroxyhexyl (meth)acrylate, and hydroxyphenyl (meth)acrylate. These may be used singly or in any combination of two or more.

Examples of the olefinic repeating units include components derived from olefinic monomers, such as ethylene, propylene, isoprene, and butadiene. These may be used singly or in any combination of two or more.

Examples of the halogen-containing repeating units include components derived from monomers such as vinyl chloride and vinylidene chloride. These may be used singly or in any combination of two or more.

Examples of the styrenic repeating units include components derived from styrenic monomers such as styrene, α-methylstyrene, and vinyltoluene. These may be used singly or in any combination of two or more.

Examples of the vinyl acetate-based repeating units include an ester of a saturated carboxylic acid and vinyl alcohol, such as vinyl acetate or vinyl propionate. These may be used singly or in any combination of two or more.

Examples of the vinyl alcohol-based repeating units include vinyl alcohol, which may have 1,2-glycol linkages in the side chain.

The copolymer may have a random copolymer, alternating copolymer, a block copolymer, or graft copolymer structure. The copolymer having a random copolymer structure facilitates the production process and preparation with other components. Thus, a random copolymer is preferable to other copolymers.

The copolymer can be obtained by radical polymerization. Radical polymerization is preferable due to the ease of industrial production. The radical polymerization may be, for example, solution polymerization, emulsion polymerization, bulk polymerization, or suspension polymerization. The radical polymerization is preferably solution polymerization. The use of solution polymerization facilitates control of the molecular weight of the copolymer.

The radical polymerization may involve diluting the above monomer with a polymerization solvent, followed by the addition of a polymerization initiator to polymerize the monomer.

The polymerization solvent may be, for example, an ester-based solvent, an alcohol ether solvent, a ketone-based solvent, an aromatic solvent, an amide-based solvent, or an alcohol-based solvent. The ester-based solvent may be, for example, methyl acetate, ethyl acetate, n-butyl acetate, isobutyl acetate, t-butyl acetate, methyl lactate, or ethyl lactate. The alcohol ether solvent may be, for example, ethylene glycol monomethyl ether, ethylene glycol monoethyl ether, propylene glycol monomethyl ether, propylene glycol monomethyl ether acetate, propylene glycol monoethyl ether, 3-methoxy-1-butanol, or 3-methoxy-3-methyl-1-butanol. The ketone-based solvent may be, for example, acetone, methyl ethyl ketone, methyl isobutyl ketone, or cyclohexanone. The aromatic solvent may be, for example, benzene, toluene, or xylene. The amide-based solvent may be, for example, formamide or dimethylformamide. The alcohol-based solvent may be, for example, methanol, ethanol, n-propanol, isopropanol, n-butanol, isobutanol, s-butanol, t-butanol, diacetone alcohol, or 2-methyl-2-butanol. The polymerization solvents may be used alone or in any mixture of two or more.

The radical polymerization initiator may be, for example, a peroxide or an azo compound. The peroxide may be, for example, benzoyl peroxide, t-butyl peroxyacetate, t-butyl peroxybenzoate, or di-t-butyl peroxide. The azo compound may be, for example, azobisisobutyronitrile, azobisamidinopropane salt, azobiscyanovaleric acid (salt), or 2,2′-azobis[2-methyl-N-(2-hydroxyethyl)propionamide].

When the total monomer is defined as 100 parts by mass, the amount of radical polymerization initiator is preferably 0.0001 parts by mass or more and 20 parts by mass or less, more preferably 0.001 parts by mass or more and 15 parts by mass or less, and still more preferably 0.005 parts by mass or more and 10 parts by mass or less. The radical polymerization initiator may be added to the monomer and the polymerization solvent before the start of the polymerization or added dropwise during the polymerization. Dropwise addition of the radical polymerization initiator to the monomer and the polymerization solvent during the polymerization is preferable in that the heat generation from the polymerization can be suppressed.

The reaction temperature during the radical polymerization is selected as appropriate depending on the types of the radical polymerization initiator and the polymerization solvent. The reaction temperature is preferably 60° C. or more and 110° C. or less from the standpoint of the ease of production and reaction controllability.

The content of the radical scavenger represented by formula (i) is preferably 1 to 95 mol % and more preferably 10 to 90 mol % relative to the total molar amount of the monomers constituting the actinic radiation curable resin.

The ultraviolet absorber can be the same as that illustrated in the transparent substrate description.

The optical film 1 according to the present embodiment with the above structure exhibits sufficient ultraviolet shielding ability corresponding to 90% or higher ultraviolet shielding efficiency measured in accordance with JIS L 1925 due to the ultraviolet absorbing layer 30, with the ultraviolet absorbing layer 30 and the hard coat layer 20 firmly adhered to each other. The copolymer contained in the actinic radiation curable resin improves the adhesion between the ultraviolet absorbing layer 30 and the hard coat layer 20, and the radical scavenger represented by formula (i) reduces the deterioration of the ultraviolet absorber, improving the lightfastness.

In the optical film 1, the ultraviolet absorbing layer 30 has good adhesion even without surface treatment or primer layer formation on the surface in contact with the ultraviolet absorbing layer 30. Furthermore, the hard coat layer 20 and the hardness of the actinic radiation curable resin after curing provide the surface on the ultraviolet absorbing layer 30 with a sufficient surface hardness of H or higher determined in a 500 g load pencil hardness test according to JIS K 5400-1990.

The ultraviolet absorbing layer 30 according to the present invention may be provided with antistatic, anti-staining, antiglare, or other properties by adding a predetermined substance.

Examples of additives for providing antistatic properties include various antistatic agents, such as fine metal oxide particles including antimony-doped tin oxide (ATO) or tin-doped indium oxide (ITO), polymer-based conductive compositions, and quaternary ammonium salts.

Examples of additives for providing anti-staining properties include various anti-staining agents, such as silicon oxides, fluorine-containing silane compounds, fluoroalkylsilazane, fluoroalkylsilane, fluorine-containing silicon-based compounds, and perfluoropolyether-containing silane coupling agents.

Examples of additives for providing antiglare properties include fine organic particles and fine inorganic particles.

The fine organic particles are materials that form microscopic surface irregularities, imparting an ambient light scattering function. Examples of the fine organic particles include resin particles of light-transmissive resin materials such as acrylic resin, polystyrene resin, styrene-(meth)acrylate copolymer, polyethylene resin, epoxy resin, silicone resin, polyvinylidene fluoride, and polytetrafluoroethylene-based resin. To adjust the refractive index or the resin particle dispersibility, a mixture of two or more types of resin particles having different materials (refractive indices) may be used.

The fine inorganic particles are materials that adjust the sedimentation and aggregation of the fine organic particles. The fine inorganic particles can be, for example, fine silica particles, fine metal oxide particles, or various fine mineral particles. The fine silica particles can be, for example, fine silica particles surface-modified with colloidal silica or a reactive functional group such as a (meth)acryloyl group. The fine metal oxide particles can be, for example, alumina (aluminum oxide), zinc oxide, tin oxide, antimony oxide, indium oxide, titania (titanium dioxide), or zirconia (zirconium dioxide). The fine mineral particles can be, for example, mica, synthetic mica, vermiculite, montmorillonite, iron montmorillonite, bentonite, beidellite, saponite, hectorite, stevensite, nontronite, magadiite, ilerite, kanemite, layered titanate, smectite, or synthetic smectite. The fine mineral particles can be either natural substances, synthetic substances (including substitution products and derivatives), or a mixture of both. Among others, the fine mineral particles are preferably a form of organoclay. The organoclay refers to swelling clay intercalated with organic onium ions. The organic onium ions are not particularly limited as long as they can organically modify the swelling clay based on its cation exchangeability. When organoclay mineral is used as fine mineral particles, the above synthetic smectite can be appropriately used.

A second embodiment of the present invention is described with reference to FIG. 2. In the following description, the same reference numerals are used for components common to those already described, and redundant description is omitted.

FIG. 2 is a schematic cross-sectional view of an optical film 2 according to the present embodiment. The optical film 2 includes a second functional layer 40 formed on the ultraviolet absorbing layer 30.

The function exhibited by the second functional layer 40 can be variously changed depending on, for example, the use of the optical film. Specific examples of the second functional layer include a low refractive index layer, an antiglare layer, an antistatic layer, and an anti-staining layer, and two or more functions may be exhibited.

The antistatic layer, the anti-staining layer, and the antiglare layer can be formed using a composition obtained by adding the above various additives to the base resin for the layer.

When the second functional layer 40 is a low refractive index layer, the refractive index can be, for example, 1.20 to 1.55. Examples of additives used for refractive index adjustment include fine particles of lithium fluoride (LiF), magnesium fluoride (MgF2), sodium hexafluoroaluminate (Greenland spar, cryolite, 3NaF·AlF3, Na3AlF6), or aluminum fluoride (AlF3) and fine silica particles. Preferable fine silica particles are particles having voids inside, such as porous fine silica particles or hollow fine silica particles.

The method for forming the low refractive index layer is not limited to a specific method, and usable formation methods include vacuum evaporation, sputtering, ion plating, ion beam deposition, plasma chemical vapor deposition, and a technique for applying a low refractive index layer forming composition to the ultraviolet absorbing layer 30, followed by curing via actinic radiation.

The thickness of the low refractive index layer may be, but is not limited to, for example, preferably 40 nm to 1 μm.

With the low refractive index layer, the optical film 2 exhibits an antireflection function.

Furthermore, the copolymer contained in the actinic radiation curable resin provides the ultraviolet absorbing layer 30 with good adhesion even without surface treatment or primer layer formation on the surface in contact with the ultraviolet absorbing layer 30. Thus, the adhesion between the ultraviolet absorbing layer 30 and the second functional layer 40 can be improved without surface treatment or primer layer formation.

A third embodiment of the present invention is described with reference to FIG. 3.

FIG. 3 is a schematic cross-sectional view of an optical film 3 according to the present embodiment. The optical film 3 includes a color layer 50 in place of the hard coat layer 20 of the optical film 1.

The color layer 50 serving as a first functional layer is a cured article of a color layer forming composition, containing dye (A), actinic radiation curable resin (B), and photoinitiator (C).

The thickness of the color layer 50 is, for example, preferably 0.5 to 10 μm. When the thickness of the color layer 50 is greater than or equal to the lower limit, the color layer 50 can contain dye without creating visual defects, and the light absorption properties of the dye can improve the reflection properties and the color reproducibility. When the thickness of the color layer 50 is smaller than or equal to the upper limit, it is advantageous for reducing the display device thickness.

The thickness of the color layer 50 can be determined by observing a cross section of the optical film taken in the thickness direction with, for example, a microscope.

### <Dye (A)>

Dye (A) contains at least one of a first colorant, a second colorant, and a third colorant described below.

The first colorant has a maximum absorption wavelength in the range of 470 nm or more and 530 nm or less with a half width of the absorption spectrum thereof of 15 nm or more and 45 nm or less. When the maximum absorption wavelength is smaller than the lower limit, the luminance efficiency of blue light emission is likely to decrease. When the maximum absorption wavelength is greater than the upper limit, the luminance efficiency of green light emission is likely to decrease. When the half width of the absorption spectrum thereof is smaller than the lower limit, the effect of suppressing ambient light reflection properties is small. When the half width of the absorption spectrum thereof is greater than the upper limit, ambient light reflection properties are likely to improve, but the luminance efficiency is likely to decrease.

The second colorant has a maximum absorption wavelength in the range of 560 nm or more and 620 nm or less with a half width of the absorption spectrum thereof of 15 nm or more and 55 nm or less. When the maximum absorption wavelength is smaller than the lower limit, the luminance efficiency of green light emission is likely to decrease. When the maximum absorption wavelength is greater than the upper limit, the luminance efficiency of red light emission is likely to decrease. When the half width of the absorption spectrum thereof is smaller than the lower limit, the effect of suppressing ambient light reflection properties is small. When the half width of the absorption spectrum thereof is greater than the upper limit, ambient light reflection properties are likely to improve, but the luminance efficiency is likely to decrease.

The third colorant has a minimum transmittance at a wavelength of 650 or more and 780 nm or less within the wavelength range of 380 to 780 nm. In the wavelength range of 400 to 780 nm for the third colorant, when the wavelength at the minimum transmittance is smaller than the lower limit, the luminance efficiency of red light emission is likely to decrease. When the wavelength at the minimum transmittance is greater than the upper limit, the effect of suppressing ambient light reflection properties is small.

Dye (A) preferably contains a compound having any one of a porphyrin structure, a merocyanine structure, a phthalocyanine structure, an azo structure, a cyanine structure, a squarylium structure, a coumarin structure, a polyene structure, a quinone structure, a tetradiporphyrin structure, a pyrromethene structure, and an indigo structure, or a metal complex thereof. In particular, a metal complex having a porphyrin structure, a pyrromethene structure, or a phthalocyanine structure or a compound having a squarylium structure is more preferable because of high reliability. Dye (A) may contain any one of these compounds or metal complexes thereof alone, or two or more in combination. These compounds or metal complexes thereof may be contained in the first colorant, the second colorant, the, the third colorant, or two or more of these colorants.

### <Radiation-Curable Compound (B)>

Radiation-curable compound (B) is a resin that polymerizes and cures upon exposure to actinic radiation such as ultraviolet radiation or an electron beam. For example, a monofunctional, bifunctional, or trifunctional or higher functional (meth)acrylate monomer or urethane (meth)acrylate can be used.

Examples of monofunctional (meth)acrylate compounds that can be contained in radiation-curable compound (B) include 2-hydroxyethyl (meth)acrylate, 2-hydroxypropyl (meth)acrylate, 2-hydroxybutyl (meth)acrylate, n-butyl (meth)acrylate, isobutyl (meth)acrylate, t-butyl (meth)acrylate, glycidyl (meth)acrylate, acryloylmorpholine, N-vinylpyrrolidone, tetrahydrofurfuryl acrylate, cyclohexyl (meth)acrylate, 2-ethylhexyl (meth)acrylate, isobornyl (meth)acrylate, isodecyl (meth)acrylate, lauryl (meth)acrylate, tridecyl (meth)acrylate, cetyl (meth)acrylate, stearyl (meth)acrylate, benzyl (meth)acrylate, 2-ethoxyethyl (meth)acrylate, 3-methoxybutyl (meth)acrylate, ethyl carbitol (meth)acrylate, phosphoric acid (meth)acrylate, ethylene oxide-modified phosphoric acid (meth)acrylate, phenoxy (meth)acrylate, ethylene oxide-modified phenoxy (meth)acrylate, propylene oxide-modified phenoxy (meth)acrylate, nonylphenol (meth)acrylate, ethylene oxide-modified nonylphenol (meth)acrylate, propylene oxide-modified nonylphenol (meth)acrylate, methoxydiethylene glycol (meth)acrylate, methoxypolyethylene glycol (meth)acrylate, methoxypropylene glycol (meth)acrylate, 2-(meth)acryloyloxyethyl-2-hydroxypropyl phthalate, 2-hydroxy-3-phenoxypropyl (meth)acrylate, 2-(meth)acryloyloxyethyl hydrogen phthalate, 2-(meth)acryloyloxypropyl hydrogen phthalate, 2-(meth)acryloyloxypropyl hexahydrohydrogen phthalate, 2-(meth)acryloyloxypropyl tetrahydrohydrogen phthalate, dimethylaminoethyl (meth)acrylate, trifluoroethyl (meth)acrylate, tetrafluoropropyl (meth)acrylate, hexafluoropropyl (meth)acrylate, octafluoropropyl (meth)acrylate, and adamantane-derived mono (meth)acrylates, such as adamantyl acrylates having monovalent mono (meth)acrylate derived from 2-adamantane or adamantanediol. The term “(meth)acryloyl” here refers to either acryloyl, methacryloyl, or both.

Examples of bifunctional (meth)acrylate compounds that can be contained in radiation-curable compound (B) include di(meth)acrylates, such as ethylene glycol di(meth)acrylate, diethylene glycol di(meth)acrylate, butanediol di(meth)acrylate, hexanediol di(meth)acrylate, nonanediol di(meth)acrylate, ethoxylated hexanediol di(meth)acrylate, propoxylated hexanediol di(meth)acrylate, diethylene glycol di(meth)acrylate, polyethylene glycol di(meth)acrylate, tripropylene glycol di(meth)acrylate, polypropylene glycol di(meth)acrylate, neopentyl glycol di(meth)acrylate, ethoxylated neopentyl glycol di(meth)acrylate, tripropylene glycol di(meth)acrylate, and neopentyl glycol hydroxypivalate di(meth)acrylate.

Examples of trifunctional or higher functional (meth)acrylate compounds that can be contained in radiation-curable compound (B) include tri(meth)acrylates, such as trimethylolpropane tri(meth)acrylate, ethoxylated trimethylolpropane tri(meth)acrylate, propoxylated trimethylolpropane tri(meth)acrylate, tris 2-hydroxyethyl isocyanurate tri(meth)acrylate, and glycerin tri(meth)acrylate, trifunctional (meth)acrylate compounds, such as pentaerythritol tri(meth)acrylate, dipentaerythritol tri(meth)acrylate, and ditrimethylolpropane tri(meth)acrylate, trifunctional or higher polyfunctional (meth)acrylate compounds, such as pentaerythritol tetra(meth)acrylate, ditrimethylolpropane tetra (meth)acrylate, dipentaerythritol tetra (meth)acrylate, dipentaerythritol penta (meth)acrylate, ditrimethylolpropane penta (meth)acrylate, dipentaerythritol hexa (meth)acrylate, and ditrimethylolpropane hexa (meth)acrylate, and polyfunctional (meth)acrylate compounds in which part of these (meth)acrylates is substituted with an alkyl group or E-caprolactone.

Other examples of resins that can be contained in radiation-curable compound (B) include urethane (meth)acrylate. Example urethane (meth)acrylate can be obtained by reacting a hydroxyl-containing (meth)acrylate monomer with a product obtained by reacting polyester polyol with an isocyanate monomer or a prepolymer.

Examples of the urethane (meth)acrylate include pentaerythritol triacrylate hexamethylene diisocyanate urethane prepolymer, dipentaerythritol pentaacrylate hexamethylene diisocyanate urethane prepolymer, pentaerythritol triacrylate toluene diisocyanate urethane prepolymer, dipentaerythritol pentaacrylate toluene diisocyanate urethane prepolymer, pentaerythritol triacrylate isophorone diisocyanate urethane prepolymer, and dipentaerythritol pentaacrylate isophorone diisocyanate urethane prepolymer.

The above-described additional monofunctional, bifunctional, or trifunctional or higher functional (meth)acrylate monomers and urethane (meth)acrylates that can be contained in radiation-curable compound (B) may be used singly or in any combination of two or more. They may also be in the form of an oligomer resulting from partial polymerization.

The copolymer containing various repeating units used for the ultraviolet absorbing layer 30 can also be contained in radiation-curable compound (B).

The content of radiation-curable compound (B) is preferably 20 to 80% by mass and more preferably 30 to 70% by mass relative to the total mass of the color layer forming composition. When the content of radiation-curable compound (B) is greater than or equal to the lower limit, fading can be reduced more effectively. When the content of radiation-curable compound (B) is smaller than or equal to the upper limit, the color layer forming composition can be handled more easily.

### <Photoinitiator (C)>

When ultraviolet light is used as actinic radiation, photoinitiator (C) is, for example, an agent that produces radicals upon exposure to the ultraviolet light.

Examples of photoinitiator (C) include benzoins (e.g., benzoin alkyl ethers such as benzoin, benzoin methyl ether, benzoin ethyl ether, benzoin isopropyl ether), phenyl ketones [e.g., alkyl phenyl ketones such as acetophenones (e.g., acetophenone, 2-hydroxy-2-methyl-1-phenylpropane-1-one, 2,2-dimethoxy-2-phenylacetophenone, 2,2-diethoxy-2-phenylacetophenone, 1,1-dichloroacetophenone) and 2-hydroxy-2-methylpropiophenone; and cycloalkyl phenyl ketones such as 1-hydroxycyclohexyl phenyl ketone], aminoacetophenones {e.g., 2-methyl-1-[4-(methylthio)phenyl]-2-morpholinoaminopropanone-1,2-benzyl-2-dimethylamino-1-(4-morpholinophenyl)-butanone-1}, anthraquinones (e.g., anthraquinone, 2-methylanthraquinone, 2-ethylanthraquinone, 2-t-butylanthraquinone, 1-chloroanthraquinone), thioxanthones (e.g., 2,4-dimethylthioxanthone, 2,4-diethylthioxanthone, 2-chlorothioxanthone, 2,4-diisopropylthioxanthone), ketals (e.g., acetophenone dimethyl ketal, benzyl dimethyl ketal), benzophenones (e.g., benzophenone), xanthones, phosphine oxides (e.g., 2,4,6-trimethylbenzoyl diphenylphosphine oxide). These photoinitiators may be used singly or in any combination of two or more.

The content of photoinitiator (C) is preferably 0.01 to 20% by mass and more preferably 0.01 to 5% by mass relative to the solid content of the color layer forming composition. When the content of photoinitiator (C) is smaller than the lower limit, the curability is insufficient. When the content of photoinitiator (C) is greater than the upper limit, unreacted photoinitiator (C) remains, degrading the reliability of properties such as heat resistance.

The color layer 50 may contain solvent (D) and additive (E). Details of the solvent and additive will now be described.

### <Solvent (D)>

Solvent (D) is used for formation of the color layer. During drying after coating, most of the solvent evaporates and disappears from the color layer. However, since the solvent partially remains in the color layer, the components are described.

Examples of solvent (D) include ethers, ketones, esters, and cellosolves. Examples of ethers include dibutyl ether, dimethoxymethane, dimethoxyethane, diethoxyethane, propylene oxide, 1,4-dioxane, 1,3-dioxolane, 1,3,5-trioxane, tetrahydrofuran, anisole, or phenetole. Examples of ketones include acetone, methyl ethyl ketone, diethyl ketone, dipropyl ketone, diisobutyl ketone, methyl isobutyl ketone, cyclopentanone, cyclohexanone, methylcyclohexanone, or ethylcyclohexanone. Examples of esters include ethyl formate, propyl formate, n-pentyl formate, methyl acetate, ethyl acetate, methyl propionate, ethyl propionate, n-pentyl acetate, or y-butyrolactone. Examples of cellosolves include methyl cellosolve, cellosolve (ethylcellosolve), butyl cellosolve, or cellosolve acetate. Solvents (D) may be used singly or in any combination of two or more.

The content of solvent (D) is preferably 20 to 80% by mass and more preferably 30 to 70% by mass relative to the total mass of the color layer forming composition containing (A) through (C). When the content of solvent (D) is greater than or equal to the lower limit, the color layer forming composition can be handled more easily. When the content of solvent (D) is smaller than or equal to the upper limit, the color layer can be formed in a shorter time.

### <Additive (E)>

Examples of additive (E) include at least a compound having the structure represented by formula (ii) below (hereinafter referred to as compound A), a radical scavenger, a singlet oxygen quencher, and a peroxide decomposer.

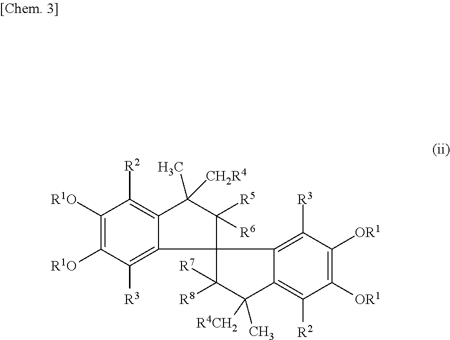

In formula (ii), R¹s each independently represent any one of an alkyl group, an alkenyl group, an aryl group, a heterocyclic group, and groups represented by R⁹CO—, R¹⁰SO₂—, and R¹¹NHCO— (where R⁹, R¹⁰, and R¹¹ each independently represent any one of an alkyl group, an alkenyl group, an aryl group, and a heterocyclic group). R² and R³ each independently represent any one of a hydrogen atom, a halogen atom, an alkyl group, an alkenyl group, an alkoxy group, and an alkenyloxy group. R⁴ to R⁸ each independently represent any one of a hydrogen atom, an alkyl group, an alkenyl group, and an aryl group.

Examples of the radical scavenger include a hindered amine-based photostabilizer such as 4-isopropylaminodiphenylamine, N-phenyl-1-naphthylamine, or 1,2,2,6,6-pentamethyl-4-piperidyl methacrylate, and a phenolic antioxidant such as 2,6-di-t-butyl-p-cresol, or 6,6′-di-t-butyl-4,4′-butylidenedi-m-cresol.

Examples of the singlet oxygen quencher include transition metal complexes, dyes, amines, phenols, and sulfides. In particular, preferable material examples include transition metal complexes of dialkylphosphate, dialkyldithiophosphate, dialkyldithiocarbonate, benzenedithiol, or similar dithiols, with nickel, zinc, copper, or cobalt being preferred as the central metal of these transition metal complexes.

The peroxide decomposer functions to decompose peroxides generated during oxidative deterioration of dyes, interrupting the autoxidation cycle and reducing dye deterioration (fading). The peroxide decomposer can be a phosphorus-based antioxidant or a sulfur-based antioxidant.

Examples of the phosphorus-based antioxidant include 2,2′-methylenebis(4,6-di-t-butyl-1-phenyloxy) (2-ethylhexyloxy) phosphorus, 3,9-bis(2,6-di-tert-butyl-4-methylphenoxy)-2,4,8,10-tetraoxa-3,9-diphosphaspiro[5.5]undecane, and 6-[3-(3-t-butyl-4-hydroxy-5-methylphenyl) propoxy]-2,4,8,10-tetra-t-butyldibenz[d,f][1,3,2]dioxaphosphepine.

Examples of the sulfur-based antioxidant include 2,2-bis({[3-(dodecylthio)propionyl]oxy}methyl)-1,3-propanediyl-bis [3-(dodecylthio)propionate], 2-mercaptobenzimidazole, dilauryl-3,3′-thiodipropionate, dimyristyl-3,3′-thiodipropionate, distearyl-3,3′-thiodipropionate, pentaerythrityl-tetrakis (3-laurylthiopropionate), and 2-mercaptobenzothiazole.

The additives contained in the color layer 50 can improve the lightfastness and heat resistance of dye (A).

Additive (E) may also contain a leveling agent, an antifoaming agent, an antioxidant, an ultraviolet absorber, a photostabilizer, a photosensitizer, or a conductive material as other additives.

When incorporated in various display devices, the optical film 3 according to the present embodiment can achieve both reflection suppression and luminance efficiency due to the included color layer 50, contributing to improvement in the display quality. In addition, the ultraviolet absorbing layer 30 located on the side on which ambient light is incident can reduce the deterioration of the color layer, maintaining the effect over a long period of time.

Furthermore, the copolymer contained in the actinic radiation curable resin provides the ultraviolet absorbing layer 30 with good adhesion even without surface treatment or primer layer formation on the surface in contact with the ultraviolet absorbing layer 30. Thus, the adhesion between the ultraviolet absorbing layer 30 and the color layer 50 can be improved without surface treatment or primer layer formation.

A fourth embodiment of the present invention is described with reference to FIG. 4.

FIG. 4 is a schematic cross-sectional view of an optical film 4 according to the present embodiment. The optical film 4 has the same structure as the optical film 3 except for an oxygen barrier layer (second functional layer) 60 provided between the ultraviolet absorbing layer 30 and the color layer 50.

The oxygen barrier layer 60 is a transparent layer having light transmittivity and serves as a second functional layer. The oxygen transmission rate of the oxygen barrier layer 60 is 10 cm³/m²·day·atm or less, more preferably 5 cm³/(m²·day·atm) or less, and still more preferably 1 cm³/(m²·day·atm) or less. When the oxygen transmission rate of the oxygen barrier layer 60 is smaller than or equal to the upper limit, sufficient oxygen barrier properties can be exhibited. The lower limit of the oxygen transmission rate of the oxygen barrier layer 60 is not limited to a particular value but may be 0 cm³/(m²·day·atm).

The material for forming the oxygen barrier layer 60 preferably contains polyvinyl alcohol (PVA), ethylene-vinyl alcohol copolymer (EVOH), vinylidene chloride, or siloxane resin, and examples include MAXIVE (registered trademark), manufactured by Mitsubishi Gas Chemical Company, Inc., EVAL, manufactured by Kuraray Co., Ltd., and PVDC Latex and PVDC Resin from Asahi Kasei Corporation. The thickness of the oxygen barrier layer 60 is not limited to a specific value as long as the desired oxygen barrier properties are provided.

Herein, the oxygen transmission rate of the oxygen barrier layer 60 is a value measured using an oxygen transmission rate tester at a temperature of 30° C. and a relative humidity of 60%.

The oxygen barrier layer 60 may also contain dispersed inorganic particles (particles of inorganic compounds). The inorganic particles can reduce the oxygen transmission rate, further reducing the oxidative deterioration (fading) of the color layer 50. The inorganic particle size and content are not limited to specific values, but may be determined as appropriate depending on, for example, the thickness of the oxygen barrier layer 60. The size (maximum length) of the inorganic particles dispersed in the oxygen barrier layer 60 is preferably smaller than the thickness of the oxygen barrier layer 60, and a smaller size is more advantageous. It is noted that the size of the inorganic particles dispersed in the oxygen barrier layer 60 may be uniform or nonuniform. Specific examples of the inorganic particles dispersed in the oxygen barrier layer 60 include silica particles, alumina particles, silver particles, copper particles, titanium particles, zirconia particles, and tin particles.

The optical film 4 according to the present embodiment includes the oxygen barrier layer 60. Thus, with the oxygen barrier layer 60 incorporated in the display device nearer to the observer than the color layer 50, oxygen from atmospheric air does not reach the color layer 50 without passing through the oxygen barrier layer 60. As a result, the colorants contained in the color layer 50 are less likely to be deteriorated by oxygen, enabling the color correction function to be maintained for a longer period of time.

Furthermore, the copolymer contained in the actinic radiation curable resin provides the ultraviolet absorbing layer 30 with good adhesion even without surface treatment or primer layer formation on the surface in contact with the ultraviolet absorbing layer 30. Thus, the adhesion between the ultraviolet absorbing layer 30 and the oxygen barrier layer 60 can be improved without surface treatment or primer layer formation.

In the present embodiment, the number and position of the oxygen barrier layer 60 can be determined appropriately.

### [Optical Film Production Method]

The optical film according to each embodiment of the present invention can be produced by any conventionally known method.

For example, for the optical film 1, a hard coating agent is first applied to one surface of the transparent substrate 10 and then cured to form the hard coat layer 20. Note that the color layer 50 may be formed in place of the hard coat layer 20. In addition, the oxygen barrier layer 60 may be formed on the color layer 50.

Then, an ultraviolet absorbing layer forming composition is applied and cured upon exposure to actinic radiation to yield the ultraviolet absorbing layer 30. The second functional layer 40 may be formed on the ultraviolet absorbing layer 30.

An ultraviolet absorbing layer forming composition according to the present invention contains an ultraviolet absorber, an actinic radiation curable resin, a photoinitiator, and a solvent. The actinic radiation curable resin contains a copolymer of the structural unit represented by formula (i) and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit.

The photoinitiator can be the same as described above for photoinitiator (C).

The light source for forming the ultraviolet absorbing layer 30 can be any light source that produces actinic radiation. The actinic radiation can be a light energy beam such as radiation (e.g., gamma ray, X-ray), ultraviolet light, visible light, or an electron beam (EB), and typically ultraviolet light or an electron beam is used. For example, the lamp for emitting ultraviolet light can be a low-pressure mercury lamp, a medium-pressure mercury lamp, a high-pressure mercury lamp, a carbon arc lamp, a metal halide lamp, a xenon lamp, or an electrodeless discharge lamp. As an irradiation condition, the ultraviolet irradiation dose is typically 100 to 1000 mJ/cm².

A 5 μm thick film formed from this ultraviolet absorbing layer forming composition has 90% or higher ultraviolet shielding efficiency, as measured in accordance with the method described in JIS L 1925.

### [Display Device]

The display device according to the present invention includes the optical film according to the present invention. Specific examples of the display device include televisions, monitors, mobile phones, portable game consoles, portable information terminals, personal computers, e-books, video cameras, digital still cameras, head-mounted displays, navigation systems, audio playback devices (e.g., car audio systems, digital audio players), copy machines, facsimiles, printers, multifunction printers, vending machines, automated teller machines (ATMs), personal authentication devices, optical communication devices, and IC cards. Among others, the optical film is preferably used for display devices including self-emissive displays, such as LEDs, organic EL devices, inorganic phosphors, or quantum dots, which are susceptible to the effects of ambient light reflection due to metal electrodes and wiring.

Although embodiments of the present invention have been described in detail with reference to the drawings, specific components are not limited to those in these embodiments. The present invention should encompass structural modifications or combinations that fall within the spirit and scope of the invention.

### EXAMPLES

The present invention will now be described in more detail by way of Examples. The technical scope of the present invention is not to be limited solely based on the specific content of the examples.

### Examples 1 to 13 and Comparative Examples 1 to 5

In the following examples and comparative examples, optical films A to R were prepared having layer structures listed in tables 1 and 2. In the tables, “-” denotes the absence of the layer.

TABLE 1

| | | EX. 1 | EX. 2 | EX. 3 | EX. 4 | EX. 5 | EX. 6 |
|---|---|---|---|---|---|---|---|
| OPTICAL FILM | | OPTICAL | OPTICAL | OPTICAL | OPTICAL | OPTICAL | OPTICAL |
| | | FILM A | FILM B | FILM C | FILM D | FILM E | FILM F |
| SECOND | | — | — | — | LOW RE- | ANTIGLARE | ANTISTATIC- |
| FUNCTIONAL LAYER | | | | | FRACTIVE | LAYER | ANTI- |
| | | | | | INDEX | | STAINING |
| | | | | | LAYER | | LAYER |
| UV | NAME | UV | UV | UV | UV | UV | UV |
| ABSORBING | | ABSORBING | ABSORBING | ABSORBING | ABSORBING | ABSORBING | ABSORBING |
| LAYER | | LAYER a | LAYER b | LAYER c | LAYER a | LAYER a | LAYER a |
| | RADICAL | RESIN 1 | RESIN 1 | RESIN 1 | RESIN 1 | RESIN 1 | RESIN 1 |
| | SCAVENGER | | | | | | |
| | COMPOUND | | | | | | |
| | OTHER | — | ANTISTATIC/ | ANTIGLARE | — | — | — |
| | FUNCTIONS, | | ANTI- | | | | |
| | ETC. | | STAINING | | | | |
| SECOND | | — | — | — | — | — | — |
| FUNCTIONAL LAYER | | | | | | | |
| FIRST | NAME | HARD COAT | HARD COAT | HARD COAT | HARD COAT | HARD COAT | HARD COAT |
| FUNCTIONAL | TYPE | LAYER | LAYER | LAYER | LAYER | LAYER | LAYER |
| LAYER | | | | | | | |

| | | | | | | |
|---|---|---|---|---|---|---|
| SUBSTRATE | TAC | TAC | TAC | TAC | TAC | TAC |

| | | EX. 7 | EX. 8 | EX. 9 | EX. 10 | EX. 11 | EX. 12 | EX. 13 |
|---|---|---|---|---|---|---|---|---|
| OPTICAL FILM | | OPTICAL | OPTICAL | OPTICAL | OPTICAL | OPTICAL | OPTICAL | OPTICAL |
| | | FILM G | FILM H | FILM I | FILM J | FILM K | FILM L | FILM M |
| SECOND | | LOW RE- | LOW RE- | LOW RE- | LOW RE- | LOW RE- | LOW RE- | LOW RE- |
| FUNCTIONAL LAYER | | FRACTIVE | FRACTIVE | FRACTIVE | FRACTIVE | FRACTIVE | FRACTIVE | FRACTIVE |
| | | INDEX | INDEX | INDEX | INDEX | INDEX | INDEX | INDEX |
| | | LAYER | LAYER | LAYER | LAYER | LAYER | LAYER | LAYER |
| UV | NAME | UV | UV | UV | UV | UV | UV | UV |
| ABSORBING | | ABSORBING | ABSORBING | ABSORBING | ABSORBING | ABSORBING | ABSORBING | ABSORBING |
| LAYER | | LAYER a | LAYER a | LAYER a | LAYER a | LAYER a | LAYER a | LAYER a |
| | RADICAL | RESIN 1 | RESIN 1 | RESIN 1 | RESIN 1 | RESIN 1 | RESIN 1 | RESIN 1 |
| | SCAVENGER | | | | | | | |
| | COMPOUND | | | | | | | |
| | OTHER | — | — | — | — | — | — | — |
| | FUNCTIONS, | | | | | | | |
| | ETC. | | | | | | | |
| SECOND | | — | — | — | OXYGEN | — | — | — |
| FUNCTIONAL LAYER | | | | | BARRIER | | | |
| | | | | | LAYER | | | |
| FIRST | NAME | COLOR | COLOR | COLOR | COLOR | COLOR | COLOR | COLOR |
| FUNCTIONAL | | LAYER a | LAYER b | LAYER c | LAYER b | LAYER d | LAYER e | LAYER b |
| LAYER | TYPE | COLOR | COLOR | COLOR | COLOR | COLOR | COLOR | COLOR |
| | | LAYER 1 | LAYER 2 | LAYER 3 | LAYER 2 | LAYER 2 | LAYER 2 | LAYER 2 |
| | | COLORANT | COLORANTS | COLORANTS | COLORANTS | COLOR- | COLOR- | COLORANTS |
| | | | | | | ANTS + | ANTS + | |
| | | | | | | RESIN 1 | RESIN 1 + | |
| | | | | | | | D1781 | |

| | | | | | | | |
|---|---|---|---|---|---|---|---|
| SUBSTRATE | TAC | TAC | TAC | TAC | TAC | TAC | PMMA |

TABLE 2

| | | COMP. EX. 1 | COMP. EX. 2 | COMP. EX. 3 | COMP. EX. 4 | COMP. EX. 5 |
|---|---|---|---|---|---|---|
| OPTICAL FILM | | OPTICAL FILM | OPTICAL FILM | OPTICAL FILM | OPTICAL FILM | OPTICAL FILM |
| | | N | O | P | Q | R |
| SECOND | | — | — | — | — | LOW |
| FUNCTIONAL LAYER | | | | | | REFRACTIVE |
| | | | | | | INDEX LAYER |
| UV | NAME | UV ABSORBING | UV ABSORBING | UV ABSORBING | HARD COAT | UV ABSORBING |
| ABSORBING | | LAYER d | LAYER e | LAYER f | LAYER | LAYER d |
| LAYER | RADICAL | — | HALS AGENT | RESIN 1 | — | — |
| | SCAVENGER | | | | | |
| | COMPOUND | | | | | |
| | OTHER | ANTISTATIC/ | ANTISTATIC/ | ANTISTATIC/ | WITHOUT | — |
| | FUNCTIONS. | ANTI-STAINING | ANTI-STAINING | ANTI-STAINING | ULTRA VIOLET | |
| | ETC. | | | REDUCED | ABSORBING | |
| | | | | AMOUNT OF | ABILITY | |
| | | | | INITIATOR | | |
| SECOND | | — | — | — | — | — |
| FUNCTIONAL LAYER | | | | | | |
| FIRST | NAME | HARD COAT | HARD COAT | HARD COAT | COLOR LAYER | COLOR LAYER |
| FUNCTIONAL | | LAYER | LAYER | LAYER | b | b |
| LAYER | TYPE | | | | COLOR LAYER | COLOR LAYER |
| | | | | | 2 COLORANTS | 2 COLORANTS |
| SUBSTRATE | | TAC | TAC | TAC | TAC | TAC |

Tables 3 and 4 show the configuration of the layer in each example.

TABLE 3

| | | EXAMPLE | | | | | | |
|---|---|---|---|---|---|---|---|---|
| | | 1-6 | 1, 4-13 | 2 | 3 | — | — | — |
| | | COMPARATIVE EXAMPLE | | | | | | |
| | | 1-4 | — | — | — | 1, 5 | 2 | 3 |
| COMPO- | LAYER | HARD | UV | UV | UV | UV | UV | UV |
| SITION | | COAT | ABSORBING | ABSORBING | ABSORBING | ABSORBING | ABSORBING | ABSORBING |
| | | LAYER | LAYER a | LAYER b | LAYER c | LAYER d | LAYER e | LAYER f |
| ACTINIC | TYPE | UA-306H/ | UA-306H/RESIN 1/DPHA/PETA | | | UA-306H/DPHA/PETA | | UA-306H/ |
| RADIATION | | DPHA/ | | | | | | RESIN 1/ |
| CURABLE | | PETA | | | | | | DPHA/ |
| RESIN | | | | | | | | PETA |
| | RATIO | 70/20/10 | 40/30/20/10 | | | 70/20/10 | | 40/30/20/10 |
| | CONTENT | 46.7% | 42.7% | 41.9% | 41.0% | 41.9% | 39.0% | 44.5% |

| PHOTO- | TYPE | Omnirad 819 | |
|---|---|---|---|
| INITIATOR | CONTENT | 3.3% | 0.7% |

| | | | |
|---|---|---|---|
| UV | TYPE | — | Tinuvin 479/Tinuvin 477/Tinuvin 970 |
| ABSORBER | RATIO | — | 16/52/32 |
| | CONTENT | — | 4.0% |

| | | | | | | | |
|---|---|---|---|---|---|---|---|
| ADDITIVE | TYPE | — | AR-110 | — | AR-110 | LA-82/ | AR-110 |
| | | | | | | AR-110 | |
| | RATIO | — | 100 | — | 100 | 34/66 | 100 |
| | CONTENT | — | 5.6% | — | 5.6% | 8.5% | 5.6% |

| ANTIGLARE | TYPE | — | | RESIN | — |
|---|---|---|---|---|---|
| PARTICLE | | | | PARTICLE/ | |
| | | | | FINE | |
| | | | | INORGANIC | |
| | | | | PARTICLE | |
| | | | | 1/FINE | |
| | | | | INORGANIC | |
| | | | | PARTICLE 2 | |
| | RATIO | — | | 2/1/4 | — |
| | CONTENT | — | | 1.8% | — |
| SOLVENT | TYPE | MEK/METHYL | MEK/METHYL | TOLUENE/ | MEK/METHYL |
| | | ACETATE | ACETATE | IPA | ACETATE |
| | RATIO | 50/50 | 50/50 | 35/15 | 50/50 |
| | CONTENT | 50.0% | 45.2% | 50.0% | 45.2% |

TABLE 4

| | | EXAMPLE | | | | |
|---|---|---|---|---|---|---|
| | | 7 | 8, 10, 13 | 9 | 11 | 12 |
| | | COMPARATIVE EXAMPLE | | | | |
| | | — | 4, 5 | — | — | — |
| COMPOSITION | LAYER | COLOR | COLOR | COLOR | COLOR | COMPOSITION |
| | | LAYER a | LAYER b | LAYER c | | |
| COLORING | FIRST COLORANT | — | DYE-1 | | | |
| MATERIAL | CONTENT | — | 0.2% | 0.2% | 0.2% | 0.2% |
| | SECOND | DYE-2 | DYE-2/ DYE-3 | | | |
| | COLORANT | | | | | |
| | RATIO | 100 | 40/60 | | | |
| | CONTENT | 0.8% | 0.5% | 0.4% | 0.5% | 0.5% |
| | THIRD COLORANT | — | — | DYE-4 | — | — |
| | CONTENT | — | — | 1.3% | — | — |
| ACTINIC | TYPE | UA-306H/DPHA/PETA | | | UA-306H/RESIN 1/DPHA/PETA | |
| RADIATION | RATIO | 70/20/10 | | | 50/20/20/10 | |
| CURABLE RESIN | CONTENT | 47.8% | 47.9% | 46.7% | 47.9% | 47.2% |

| PHOTOINITIATOR | TYPE | Omnirad 819 | |
|---|---|---|---|
| | CONTENT | 1.4% | |
| SOLVENT | TYPE | MEK/METHYL ACETATE | |
| | RATIO | 50/50 | |
| | CONTENT | 50.0% | |
| ADDITIVE | TYPE | — | D1781 |
| | RATIO | — | 100 |
| | CONTENT | — | 0.7% |

### Preparation of Optical Film

Each layer of the optical film will now be described in detail.

### <Transparent Substrate>

The materials listed in tables 1 and 2 are described in detail below.
TAC: triacetylcellulose film (TG60UL, manufactured by FUJIFILM Corporation, substrate thickness 60 μm, ultraviolet shielding efficiency 92.9%)
PMMA: polymethyl methacrylate film (W002N80, manufactured by SUMITOMO CHEMICAL COMPANY, LIMITED, substrate thickness 80 μm, ultraviolet shielding efficiency 13.9%)

### <Hard Coat Layer and Ultraviolet Absorbing Layer>

The materials listed in table 3 are described in detail below.
Actinic radiation curable resin

Resin 1: a polymer containing the structural unit represented by formula (i), where R¹ represents CH₃, R² represents CH₃, and X represents a single bond, or a resin having an amine structure (molecular weight 120000)

UA-306H: pentaerythritol triacrylate hexamethylene diisocyanate urethane prepolymer (UA-306H, manufactured by Kyoeisha Chemical Co., Ltd.)

DPHA: dipentaerythritol hexaacrylate

PETA: pentaerythritol triacrylate

### Production Example of Resin 1

A mixture of 2.4 g of 1,2,2,6,6-pentamethyl-4-piperidyl methacrylate (FA-711 MM, manufactured by Showa Denko Materials Co., Ltd.), 5.6 g of methyl methacrylate (manufactured by Kanto Chemical Co., Inc.), 31 g of cyclohexanone (manufactured by Kanto Chemical Co., Inc.), and 0.11 g of 2,2′-azobis(isobutyronitrile) (manufactured by FUJIFILM Wako Pure Chemical Corporation) was placed in a reaction vessel, which was purged with nitrogen gas and heated with stirring at 70° C. for 8 hours. Subsequently, the mixture was stirred and heated at 100° C. for 1 hour to yield a polymer solution. This polymer solution was poured into 400 mL of methanol (manufactured by Kanto Chemical Co., Inc.), and the resultant precipitate was collected by filtration and dried to yield resin 1 copolymerized with 1,2,2,6,6-pentamethyl-4-piperidyl methacrylate:methyl methacrylate=15:85 [mol %].
Photoinitiator

Omnirad 819: acylphosphine oxide-based photoinitiator (manufactured by IGM Resins B.V.)
Ultraviolet (UV) absorber

Tinuvin 477: hydroxyphenyl triazine-based ultraviolet absorber, Tinuvin (registered trademark) 477 (manufactured by BASF Japan Ltd.)

Tinuvin 479: hydroxyphenyl triazine-based ultraviolet absorber, Tinuvin (registered trademark) 479 (manufactured by BASF Japan Ltd.)

Tinuvin 970: hydroxyphenyl triazine-based ultraviolet absorber, Tinuvin (registered trademark) 970 (manufactured by BASF Japan Ltd.)
Additive

### (Anti-Staining Agent)

Optool (registered trademark) AR-110 (manufactured by Daikin Industries, Ltd., solid content 15%, solvent: methyl isobutyl ketone)

### (HALS Agent (Hindered Amine-Based Photostabilizer))

ADEKASTAB LA-82 (manufactured by ADEKA, molecular weight 239)
Antiglare particle

### (Resin Particle)

Styrene-methyl methacrylate copolymer particles (refractive index 1.515, mean particle diameter 2.0 μm)

### (Fine Inorganic Particle)

Fine inorganic particle 1: synthetic smectite

Fine inorganic particle 2: alumina nanoparticle (mean particle diameter 40 nm)
Solvent

MEK: methyl ethyl ketone

Methyl acetate: methyl acetate

Toluene: toluene

IPA: isopropyl alcohol

### [Formation of Hard Coat Layer and Ultraviolet Absorbing Layer]

In each example, the hard coat layer or ultraviolet absorbing layer forming composition having the formulation shown in table 3 was applied to the corresponding layer and dried for 60 seconds in an oven at 80° C. Subsequently, the coating was cured by ultraviolet irradiation with an exposure dose of 150 mJ/cm² using an ultraviolet emission device (H bulb, a light source manufactured by Fusion UV Systems Japan K.K.) to form a hard coat layer and an ultraviolet absorbing layer having a cured film thickness of 5.0 μm. In table 3, the content refers to mass ratio (% by mass), and “-” denotes the absence of the component.

### <Low Refractive Index Layer>

Details of a low refractive index layer forming composition will now be described.
Refractive index adjuster

Porous fine silica particle (mean particle diameter 75 nm, solid content 20%) dispersion in methyl isobutyl ketone 8.5 parts by mass
Anti-staining agent

Optool (registered trademark) AR-110 5.6 parts by mass
Actinic radiation curable resin

PETA 0.4 parts by mass
Photoinitiator

Omnirad TPO (manufactured by IGM Resins B.V.) 0.07 parts by mass
Leveling agent

RS-77 (manufactured by DIC Corporation) 1.7 parts by mass
Solvent

Methyl isobutyl ketone 83.73 parts by mass

### [Formation of Low Refractive Index Layer]

The above-described low refractive index layer forming composition was applied to the ultraviolet absorbing layer and dried for 60 seconds in an oven at 80° C. Subsequently, the coating was cured by ultraviolet irradiation with an exposure dose of 200 mJ/cm² using an ultraviolet emission device (H bulb, a light source manufactured by Fusion UV Systems Japan K.K.) to form a low refractive index layer having a cured film thickness of 100 nm.

### <Antiglare Layer>

Details of an antiglare layer forming composition will now be described.
Actinic radiation curable resin

Pentaerythritol triacrylate, Light Acrylate PE-3A (manufactured by Kyoeisha Chemical Co., Ltd., refractive index 1.52) 43.7 parts by mass
Photoinitiator

Omnirad TPO 4.55 parts by mass
Resin particle

Styrene-methyl methacrylate copolymer particles (refractive index 1.515, mean particle diameter 2.0 μm) 0.5 parts by mass
Fine inorganic particle

Synthetic smectite 0.25 parts by mass

Alumina nanoparticles (mean particle diameter 40 nm) 1.0 part by mass
Solvent

Toluene 15 parts by mass

Isopropyl alcohol 35 parts by mass

### [Formation Antiglare Layer]

In the corresponding example, the above-described antiglare layer forming composition was applied to the ultraviolet absorbing layer and dried for 60 seconds in an oven at 80° C. Subsequently, the coating was cured by ultraviolet irradiation with an exposure dose of 150 mJ/cm² using an ultraviolet emission device (H bulb, a light source manufactured by Fusion UV Systems Japan K.K.) to form an antiglare layer having a cured film thickness of 5.0 μm.

### <Antistatic-Anti-Staining Layer>

Details of an antistatic-anti-staining layer forming composition will now be described.
Anti-staining agent

Optool (registered trademark) AR-110 5.6 parts by mass
Actinic radiation curable resin

PETA 0.4 parts by mass
Photoinitiator

Omnirad TPO 0.07 parts by mass
Leveling agent

RS-77 1.7 parts by mass
Solvent

Methyl isobutyl ketone 91.6 parts by mass

### [Formation of Antistatic-Anti-Staining Layer]

In the corresponding example, the above-described antistatic-anti-staining layer forming composition was applied to the ultraviolet absorbing layer and dried for 60 seconds in an oven at 80° C. Subsequently, the coating was cured by ultraviolet irradiation with an exposure dose of 200 mJ/cm² using an ultraviolet emission device (H bulb, a light source manufactured by Fusion UV Systems Japan K.K.) to form an antistatic-anti-staining layer having a cured film thickness of 100 nm.

### <Oxygen Barrier Layer>

As an oxygen barrier layer forming composition, 80% by mass aqueous solution of PVA (Kuraray Poval (registered trademark) PVA-117 (manufactured by Kuraray Co., Ltd.)) was used.

In the corresponding example, this composition was applied to the color layer and dried to form an oxygen barrier layer having an oxygen transmission rate of 1 cm³/(m²·day·atm).

### <Color Layer>

Details of the materials used for the color layer will now be described. For the colorants, the maximum absorption wavelength, the half width thereof, and the minimum transmittance wavelength within a specified wavelength range refer to values for a cured coating with a thickness of 5 μm.

### <Dye (A)>

First colorant

Dye-1: pyrromethene cobalt complex dye (maximum absorption wavelength 493 nm, half width 26 nm)

### Production Example of Dye-1

Ethyl 5-formyl-2,4-dimethyl-1H-pyrrole-3-carboxylate (2.5 g) was charged into a reaction vessel and dissolved in methanol (50 mL), followed by the addition of 47% hydrobromic acid (45 g) and refluxing for 1 hour. The precipitated solid was collected by filtration to yield 3,3′,5,5′-tetramethyl-4,4′-di-ethoxycarbonyl-2,2′-dipyrromethene hydrobromide (2.6 g).

The 3,3′,5,5′-tetramethyl-4,4′-di-ethoxycarbonyl-2,2′-dipyrromethene hydrobromide (0.6 g) was charged into a reaction vessel, followed by the addition of methanol (5 mL), triethylamine (0.17 g), and cobalt acetate tetrahydrate (0.18 g) and refluxing for 2 hours. The precipitated solid was collected by filtration to yield Dye-1 (0.42 g).
Second colorant

Dye-2: tetraazaporphyrin copper complex dye (PD-311S, manufactured by Yamamoto Chemicals, Inc., maximum absorption wavelength 586 nm, half width 22 nm)

Dye-3: tetraazaporphyrin copper complex dye (FDG-007, manufactured by Yamada Chemical Co., Ltd., maximum absorption wavelength 595 nm, half width 22 nm)
Third colorant

Dye-4: phthalocyanine copper complex dye (FDN-002, manufactured by Yamada Chemical Co., Ltd., minimum transmittance wavelength within 380 to 780 nm: 780 nm)

### <Radiation-Curable Compound (B)>

Resin 1: the same as used for the ultraviolet absorbing layer
UA-306H
DPHA
PETA

### <Photoinitiator (C)>

Omnirad 819

### <Solvent (D)>

MEK: methyl ethyl ketone
Methyl acetate

### <Additive (E)>

D1781: singlet oxygen quencher (bis(dibutyldithiocarbamate) nickel(II), manufactured by Tokyo Chemical Industry Co., Ltd.)

### [Formation of Color Layer]

In the corresponding example, the above-described color layer forming composition was applied to the transparent substrate and dried for 60 seconds in an oven at 80° C. Subsequently, the coating was cured by ultraviolet irradiation with an exposure dose of 150 mJ/cm² using an ultraviolet emission device (H bulb, a light source manufactured by Fusion UV Systems Japan K.K.) to form a color layer having a cured film thickness of 5.0 nm.

The optical film in each example was evaluated as described below.

### [Evaluation of Film Properties]

### <Ultraviolet Shielding Efficiency of Ultraviolet Absorbing Layer>

The layer structure above the first functional layer in each example was formed on a glass substrate and peeled off with cellophane tape compliant with the JIS K 5600 adhesion test. An automatic spectrophotometer (U-4100, manufactured by Hitachi, Ltd.) was used to measure the transmittance of the cellophane tape used for the peeling and measure the transmittance of the layer structure using the cellophane tape alone as a reference. The obtained transmittance was used to calculate the average transmittance [%] in an ultraviolet region (290 nm to 400 nm), and the ultraviolet shielding efficiency [%] was calculated by subtracting the average transmittance [%] in the ultraviolet region (290 nm to 400 nm) from 100%. The ultraviolet shielding efficiency is preferably 90% or higher and more preferably 95% or higher, and the ultraviolet shielding efficiency may be 100%.

### <Adhesion Test>

In accordance with JIS K 5600-5-6:1999, the optical film in each example was cross-cut with a 10×10 grid at 1 mm spacing on the surface on the first surface (the functional layer side), followed by an adhesive tape adhesion test, and the retention rate of the coating was visually evaluated. The evaluation results corresponding to classifications 0, 1, and 2 as described in the above-mentioned JIS standard were recorded as Pass, whereas the evaluation results corresponding to classifications 3, 4, and 5 were recorded as Fail.

### <Pencil Hardness Test>

In accordance with JIS K 5600-5-4:1999, the optical film in each example was subjected to a pencil hardness test with a pencil (UNI, manufactured by MITSUBISHI PENCIL COMPANY, LIMITED, pencil hardness H) under a 500 gf (4.9 N) load on the surface on the first surface using a Clemens scratch hardness tester (HA-301, manufactured by Tester Sangyo Co., Ltd.). Changes in appearance due to scratching were visually evaluated, and the evaluation results of the absence of observable scratches were recorded as Pass, whereas the evaluation results of the presence of observable scratches were recorded as Fail.

### <Lightfastness Test>

The obtained optical film was subjected to a lightfastness test using a xenon weather meter (X75, manufactured by Suga Test Instruments Co., Ltd.) at a xenon lamp irradiation of 60 W/m² (300 nm to 400 nm), a chamber temperature of 45° C., and a humidity of 50% RH for 120 hours. Before and after the test, an automatic spectrophotometer (U-4100, manufactured by Hitachi, Ltd.) was used to measure transmittance, calculating the difference in ultraviolet shielding efficiency ΔT(290-400 nm) before and after the test. The difference in ultraviolet shielding efficiency becomes more favorable as it approaches zero. The difference |ΔT(290-400 nm)| is preferably smaller than or equal to 10, and more preferably the difference |ΔT(290-400 nm)| is smaller than or equal to 5.

For the examples and comparative examples with the color layer included, the pretest-to-posttest difference in transmittance ΔTλ1 at wavelength λ1, which indicates the pretest minimum transmittance in the wavelength range of 470 nm to 530 nm, was calculated together with the pretest-to-posttest difference in transmittance ΔTλ2 at wavelength λ2, which indicates the pretest minimum transmittance in the wavelength range of 560 nm to 620 nm. The difference in transmittance becomes more favorable as it approaches zero. The difference |ΔTλN| is preferably smaller than or equal to 20 (N=1 to 2), and more preferably the difference |ΔTλN| is smaller than or equal to 10 (N=1 to 2).

### [Evaluation of Display Device Properties]

### <White Display Transmission Property>

The transmittance of the obtained optical film was measured using an automatic spectrophotometer (U-4100, manufactured by Hitachi, Ltd.). Based on this transmittance, the efficiency of light transmitted through the optical film during white display was calculated and evaluated as the white display transmission property. As a reference, the efficiency of the spectrum during white display output through a white organic EL light source having the spectrum shown in FIG. 5 and a color filter was defined as 100. A value closer to 100 indicates higher white display transmittance and better luminance efficiency.

### <Display Device Reflection Property>

The transmittance T(λ) and surface reflectance R2(λ) of the obtained optical film were measured using an automatic spectrophotometer (U-4100). For the measurement of the surface reflectance R2(λ), an anti-reflective treatment was provided on the transparent substrate by applying a matte black dye to the surface without the ultraviolet absorbing layer or other layers formed on it. Then, the spectral reflectance at an incidence angle of 5° was measured as the surface reflectance R2(λ). With the electrode reflectance R_{E}(λ) assumed to be 100% across the wavelength range of 380 nm to 780 nm, the reflectance of the display device without any optical film with respect to the D65 illuminant (CIE (International Commission on Illumination) standard illuminant D65) was set as 100. Under these conditions, the relative reflectance was calculated based on formulas (1) to (4) below, and the surface reflectance R(λ) of the outermost surface nearest the observer was evaluated as the display device reflection properties. As the value of the display device reflection properties decrease, the ambient light reflection can be reduced more effectively, and the reflection properties become better. In formulas (1) to (4), R1(λ) represents an internal reflection component, Y represents one of the tristimulus values at the white point of the D65 illuminant, P_{D65}(λ) represents the spectrum of the D65 illuminant, and y-bar (λ) represents a CIE 1931 color matching function.

$$\begin{matrix}[ Math . 1 ] & \\ R 1 ( λ ) [ \% ] = \frac{( 100 - R 2 ( λ ) )}{100} \times \frac{T ( λ )}{100} \times \frac{T ( λ )}{100} \times {R}_{E} ( λ ) & ( 1 )\end{matrix}$$

$$\begin{matrix}[ Math . 2 ] & \\ R ( λ ) [ \% ] = R 1 ( λ ) + R 2 ( λ ) & ( 2 )\end{matrix}$$

$$\begin{matrix}[ Math . 3 ] & \\ Y = k \times {\int }_{380}^{780} {P}_{D 65} ( λ ) \times R ( λ ) \times \overline{y} ( λ ) d λ & ( 3 )\end{matrix}$$

$$\begin{matrix}[ Math . 4 ] & \\ k = 100 / {\int }_{380}^{780} {P}_{D 65} ( λ ) \times \overline{y} ( λ ) d λ & ( 4 )\end{matrix}$$

For the examples and comparative examples with the color layer included, color reproducibility was additionally evaluated based on the following procedure.

### <Color Reproducibility>

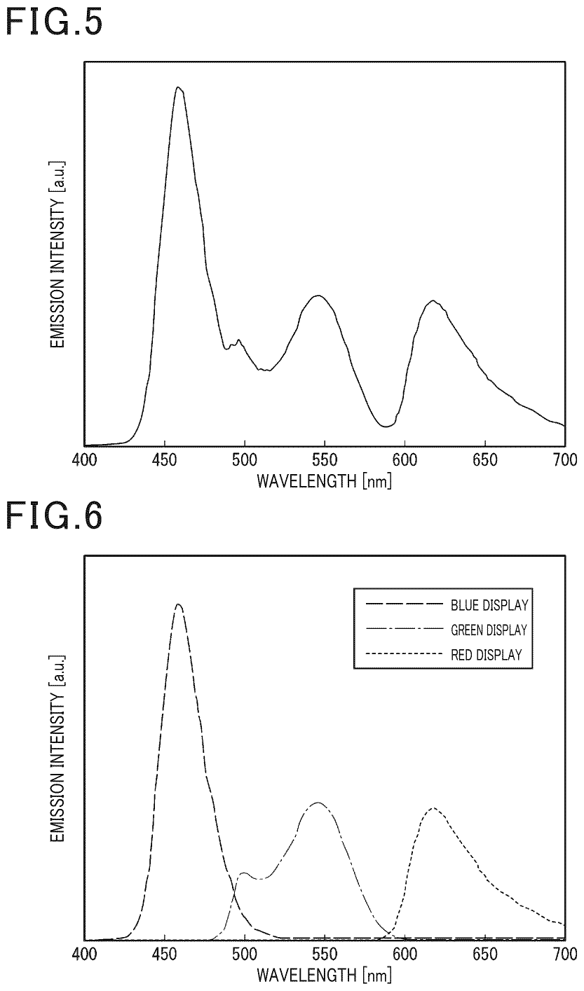

The transmittance of the obtained optical film was measured using an automatic spectrophotometer (U-4100). In the spectrum shown in FIG. 5, the red display, green display, and blue display spectra in FIG. 6 output through the white EL light source and the color filter were measured. The vertical axes of the graphs in FIGS. 5 and 6 represent emission intensity [a.u.] (arbitrary unit). The measured transmittance and red display, green display, and blue display spectra in FIG. 6 were used to calculate the CIE 1931 chromaticity values, from which the NTSC (National Television System Committee) coverage was calculated. The NTSC coverage was evaluated as an indicator of color reproducibility. A higher NTSC coverage indicates higher color reproducibility.

The results are listed in tables 5 to 9. The white display transmission properties and the display device reflection properties are presented along with percentage relative to Comparative Example 1, which has no color layer and serves as a reference (100%).

TABLE 5

| | EX. 1 | EX. 2 | EX. 3 | EX. 4 | EX. 5 | EX. 6 |
|---|---|---|---|---|---|---|
| ULTRA VIOLET | 93.0% | 93.0% | 93.0% | 93.0% | 93.0% | 93.0% |
| SHIELDING | | | | | | |
| EFFICIENCY | | | | | | |
| OF UV | | | | | | |
| ABSORBING | | | | | | |
| LAYER | | | | | | |
| ADHESION | PASS | PASS | PASS | PASS | PASS | PASS |
| TEST | | | | | | |
| PENCIL | PASS | PASS | PASS | PASS | PASS | PASS |
| HARDNESS | | | | | | |
| TEST | | | | | | |

| | EX. 7 | EX. 8 | EX. 9 | EX. 10 | EX. 11 | EX. 12 | EX. 13 |
|---|---|---|---|---|---|---|---|
| ULTRA VIOLET | 93.0% | 93.0% | 93.0% | 93.0% | 93.0% | 93.0% | 93.0% |
| SHIELDING | | | | | | | |
| EFFICIENCY | | | | | | | |
| OF UV | | | | | | | |
| ABSORBING | | | | | | | |
| LAYER | | | | | | | |
| ADHESION | PASS | PASS | PASS | PASS | PASS | PASS | PASS |
| TEST | | | | | | | |
| PENCIL | PASS | PASS | PASS | PASS | PASS | PASS | PASS |
| HARDNESS | | | | | | | |
| TEST | | | | | | | |

TABLE 6

| | COMP. | COMP. | COMP. | COMP. | COMP. |
|---|---|---|---|---|---|
| | EX. 1 | EX. 2 | EX. 3 | EX. 4 | EX. 5 |
| ULTRAVIOLET | 93.0% | 93.0% | 93.0% | 7.2% | 93.0% |
| SHIELDING | | | | | |
| EFFICIENCY OF | | | | | |
| UV ABSORBING | | | | | |
| LAYER | | | | | |
| ADHESION TEST | FAIL | FAIL | PASS | PASS | FAIL |
| HARDNESS TEST | PASS | PASS | FAIL | PASS | PASS |

TABLE 7

| LIGHTFASTNESS TEST | | EX. 1 | EX. 2 | EX. 3 | EX. 4 | EX. 5 | EX. 6 |
|---|---|---|---|---|---|---|---|
| COLOR LAYER | ΔTλ1 | — | — | — | — | — | — |
| | ΔTλ2 | — | — | — | — | — | — |
| UV ABSORBING | ΔT (290- | 2.9 | 2.9 | 3.0 | 3.0 | 3.1 | 2.9 |
| LAYER | 400 nm) | | | | | | |
| WHITE DISPLAY | | 91.4 | 91.4 | 91.4 | 91.4 | 91.4 | 91.4 |
| TRANSMISSION PROPERTY | | | | | | | |
| | RELATIVE TO | 100% | 100% | 100% | 100% | 100% | 100% |
| | COMP. EX. 1 | | | | | | |
| DISPLAY DEVICE | | 33.8 | 33.8 | 33.8 | 33.8 | 33.8 | 33.8 |
| REFLECTION PROPERTY | | | | | | | |
| | RELATIVE TO | 100% | 100% | 100% | 100% | 100% | 100% |
| | COMP. EX. 1 | | | | | | |

TABLE 8

| LIGHTFASTNESS TEST | | EX. 7 | EX. 8 | EX. 9 | EX. 10 | EX. 11 | EX. 12 | EX. 13 |
|---|---|---|---|---|---|---|---|---|
| COLOR LAYER | ΔTλ1 | — | 19.2 | 19.1 | 7.9 | 10.0 | 5.6 | 19.3 |
| | ΔTA2 | 4.6 | 3.9 | 3.7 | 3.9 | 2.1 | 1.8 | 4.0 |
| UV ABSORBING | ΔT (290- | 3.1 | 3.0 | 3.0 | 3.1 | 3.1 | 3.0 | 3.2 |
| LAYER | 400 nm) | | | | | | | |
| WHITE DISPLAY | | 61.0 | 61.4 | 59.1 | 61.4 | 61.4 | 61.4 | 61.4 |
| TRANSMISSION PROPERTY | | | | | | | | |
| | RELATIVE TO | 67% | 67% | 65% | 67% | 67% | 67% | 67% |
| | COMP. EX. 1 | | | | | | | |
| DISPLAY DEVICE | | 16.2 | 14.6 | 13.6 | 14.6 | 14.6 | 14.6 | 14.6 |
| REFLECTION PROPERTY | | | | | | | | |
| | RELATIVE TO | 48% | 43% | 40% | 43% | 43% | 43% | 43% |
| | COMP. EX. 1 | | | | | | | |
| COLOR | NTSC | 100.9% | 98.9% | 97.9% | 98.9% | 98.9% | 98.9% | 98.9% |
| REPRODUCIBILITY | COVERAGE | | | | | | | |

TABLE 9

| | | COMP. | COMP. | COMP. | COMP. | COMP. |
|---|---|---|---|---|---|---|
| LIGHTFASTNESS TEST | | EX. 1 | EX. 2 | EX. 3 | EX. 4 | EX. 5 |
| COLOR LAYER | ΔTλ1 | — | — | — | 42.9 | 22.1 |
| | ΔTλ2 | — | — | — | 42.1 | 5.1 |
| UV ABSORBING | ΔT (290- | 10.1 | 5.4 | 12.4 | — | 10.2 |
| LAYER | 400 nm) | | | | | |
| WHITE DISPLAY | | 91.4 | 91.4 | 91.4 | 61.4 | 61.4 |
| TRANSMISSION PROPERTY | | | | | | |
| | RELATIVE TO | 100% | 100% | 100% | 67% | 67% |
| | COMP. EX. 1 | | | | | |
| DISPLAY DEVICE | | 33.8 | 33.8 | 33.8 | 14.6 | 14.6 |
| REFLECTION PROPERTY | | | | | | |
| | RELATIVE TO | 100% | 100% | 100% | 43% | 43% |
| | COMP. EX. 1 | | | | | |
| COLOR | NTSC | — | — | — | 98.9% | 98.9% |
| REPRODUCIBILITY | COVERAGE | | | | | |

The results of Example 2, Comparative Example 1, and Comparative Example 2 indicate that in the ultraviolet absorbing layer, the radical scavenger compound containing the structural unit represented by formula (i) improves the adhesion.

The results of Example 2 and Comparative Example 3, in which the ultraviolet absorbing layer contained a smaller amount of photoinitiator than that in Example 2, indicate that sufficient photopolymerization is needed for the optical film to have sufficient surface hardness.

The results of Examples 2 and 3 indicate that the ultraviolet absorbing layer can be provided with antistatic, anti-staining, and antiglare properties with the physical properties maintained.

The results of Examples 4 to 13 indicate that the physical properties can be satisfied even when the ultraviolet absorbing layer and the second functional layer, such as a low refractive index layer, an antistatic-anti-staining layer, and an antiglare layer, are provided separately.

The results of Example 8, Comparative Example 4, and Comparative Example 5, with the color layer included, indicate that the optical film including the ultraviolet absorbing layer containing the structural unit represented by formula (i) can improve the lightfastness of the color layer. In Comparative Example 5, with the ultraviolet absorbing layer containing no structural unit represented by formula (i), the faster deterioration of the ultraviolet absorbing layer relative to Example 8 is believed to have caused the above finding.

The results of Examples 8 and 10 indicate that the oxygen barrier layer provided as the second functional layer further improves the lightfastness of the color layer.

The results of Example 8 (the sample including the color layer), Example 11 (the sample containing resin 1 in the color layer), and Example 12 (the sample containing resin 1 and a singlet oxygen quencher in the color layer) indicate that the color layer containing a radical scavenger or a singlet oxygen quencher improves the lightfastness of the color layer.

The results of Example 8 (TAC substrate) and Example 13 (PMMA substrate) indicate that a transparent substrate other than TAC also allows the production of an optical film satisfying intended physical properties and optical properties.

The display device including the optical film in Examples 7 to 9, in which a color layer is provided as the first functional layer, has reflection properties improved significantly compared with the display device including the optical film in Example 1, in which no color layer is included.

It is commonly known that display devices equipped with circular polarizers typically have about half the transmittance. However, as indicated by the evaluation values of white display transmission property, the display devices including the optical films in Examples 7 to 9 have excellent luminance efficiency and also exhibit higher color reproducibility.

The results of Examples 7 to 9 have revealed that broader absorption wavelength ranges tend to result in better reflection properties.

Reference Signs List

| | | | |
|---|---|---|---|
| 1, 2, 3, 4 | Optical film | 10 | Transparent substrate |
| 20 | Hard coat layer (first | 30 | Ultraviolet absorbing layer |
| | functional layer) | | |
| 40 | Second functional layer | 50 | Color layer (first functional |
| | | | layer) |

What is claimed is:

1. An optical film comprising:
a first functional layer;
an ultraviolet absorbing layer located on a first surface of the first functional layer; and
a transparent substrate located on a second surface of the first functional layer;
wherein the ultraviolet absorbing layer contains
an actinic radiation curable resin, and
an ultraviolet absorber,
the actinic radiation curable resin contains a copolymer of a structural unit represented by formula (i) and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit, and
the optical film has 90% or higher ultraviolet shielding efficiency as measured in accordance with JIS L 1925 and H or higher pencil hardness at a 500 g load on a surface on the first surface, 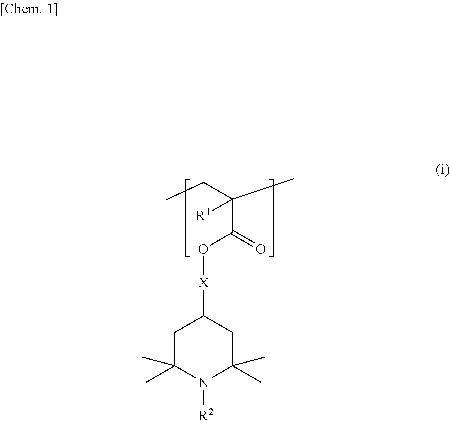
wherein
R¹ represents a hydrogen atom, a halogen atom, a carboxyl group, a sulfo group, a cyano group, a hydroxyl group, an alkyl group having ten or fewer carbon atoms, an alkoxycarbonyl group having ten or fewer carbon atoms, an alkylsulfonylaminocarbonyl group having ten or fewer carbon atoms, an arylsulfonylaminocarbonyl group, an alkylsulfonyl group, an arylsulfonyl group, an acylaminosulfonyl group having ten or fewer carbon atoms, an alkoxy group having ten or fewer carbon atoms, an alkylthio group having ten or fewer carbon atoms, an aryloxy group having ten or fewer carbon atoms, a nitro group, an alkoxycarbonyloxy group, an aryloxycarbonyloxy group, an acyloxy group having ten or fewer carbon atoms, an acyl group having ten or fewer carbon atoms, a carbamoyl group, a sulfamoyl group, an aryl group having ten or fewer carbon atoms, a substituted amino group, a substituted ureide group, a substituted phosphono group, or a heterocyclic group; R² represents a hydrogen atom or an alkyl group having 30 or fewer carbon atoms; and X represents a single bond, an ester group, an aliphatic alkyl chain having 30 or fewer carbon atoms, an aromatic chain, a polyethylene glycol chain, or a linking group formed of a combination thereof, each optionally containing a spirodioxane ring.

2. The optical film according to claim 1, wherein
the ultraviolet absorbing layer has at least one of an antistatic function, an anti-staining function, and an antiglare function.

3. The optical film according to claim 1, further comprising:
a second functional layer located over the first surface of the first functional layer and having a different function than the first functional layer.

4. The optical film according to claim 3, wherein
the second functional layer has at least one of an antireflection function and an antiglare function.

5. The optical film according to claim 3, wherein
the second functional layer is an antistatic layer or an anti-staining layer.

6. The optical film according to claim 3, wherein
the second functional layer is an oxygen barrier layer having an oxygen transmission rate of 10 cm³/(m²·day·atm) or less.

7. The optical film according to claim 1, wherein
the first functional layer contains at least one of a first colorant, a second colorant, and a third colorant,
the first colorant has a maximum absorption wavelength ranging from 470 to 530 nm with a half width of an absorption spectrum thereof of 15 to 45 nm,
the second colorant has a maximum absorption wavelength ranging from 560 to 620 nm with a half width of an absorption spectrum thereof of 15 to 55 nm, and
the third colorant has a minimum transmittance at a wavelength ranging from 650 to 780 nm within a wavelength range of 380 to 780 nm.

8. The optical film according to claim 7, wherein
the first functional layer contains a copolymer of the structural unit represented by formula (i) and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit.

9. The optical film according to claim 7, wherein
the first functional layer contains at least one of a radical scavenger, a peroxide decomposer, and a singlet oxygen quencher.

10. The optical film according to claim 9, wherein
the singlet oxygen quencher contains any one of dialkylphosphate, dialkyldithiocarbonate, benzenedithiol, and a transition metal complex thereof.

11. The optical film according to claim 7, wherein
at least one of the first colorant, the second colorant, and the third colorant contained in the first functional layer contains at least one compound selected from the group consisting of compounds having any one of a porphyrin structure, a merocyanine structure, a phthalocyanine structure, an azo structure, a cyanine structure, a squarylium structure, a coumarin structure, a polyene structure, a quinone structure, a tetradiporphyrin structure, a pyrromethene structure, and an indigo structure and metal complexes thereof.

12. A display device comprising the optical film according to claim 1.

13. An ultraviolet absorbing layer forming composition comprising:
an ultraviolet absorber;
an actinic radiation curable resin;
a photoinitiator; and
a solvent,
wherein the actinic radiation curable resin contains a copolymer of a structural unit represented by formula (i) and a structural unit having any one of a (meth)acrylate-based repeating unit, an olefinic repeating unit, a halogen-containing repeating unit, a styrenic repeating unit, a vinyl acetate-based repeating unit, and a vinyl alcohol-based repeating unit, and
when a film is formed with a thickness of 5 μm, the film has 90% or higher ultraviolet shielding efficiency as measured in accordance with JIS L 1925, 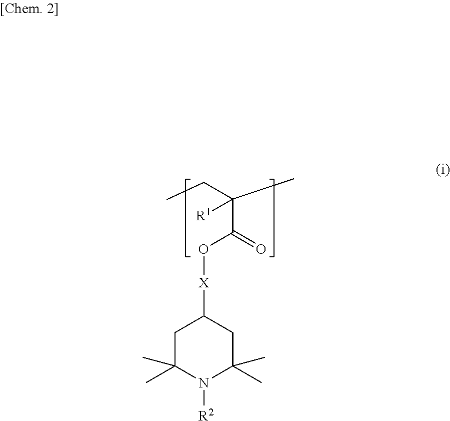
wherein R¹ represents a hydrogen atom, a halogen atom, a carboxyl group, a sulfo group, a cyano group, a hydroxyl group, an alkyl group having ten or fewer carbon atoms, an alkoxycarbonyl group having ten or fewer carbon atoms, an alkylsulfonylaminocarbonyl group having ten or fewer carbon atoms, an arylsulfonylaminocarbonyl group, an alkylsulfonyl group, an arylsulfonyl group, an acylaminosulfonyl group having ten or fewer carbon atoms, an alkoxy group having ten or fewer carbon atoms, an alkylthio group having ten or fewer carbon atoms, an aryloxy group having ten or fewer carbon atoms, a nitro group, an alkoxycarbonyloxy group, an aryloxycarbonyloxy group, an acyloxy group having ten or fewer carbon atoms, an acyl group having ten or fewer carbon atoms, a carbamoyl group, a sulfamoyl group, an aryl group having ten or fewer carbon atoms, a substituted amino group, a substituted ureide group, a substituted phosphono group, or a heterocyclic group; R² represents a hydrogen atom or an alkyl group having 30 or fewer carbon atoms; and X represents a single bond, an ester group, an aliphatic alkyl chain having 30 or fewer carbon atoms, an aromatic chain, a polyethylene glycol chain, or a linking group formed of a combination thereof, each optionally containing a spirodioxane ring.
